(19) United States
(12) Patent Application Publication
(10) Pub. No.: US 2023/0116878 A1
(43) Pub. Date: Apr. 13, 2023

(54) SYSTEM FOR LOCATION-BASED REAL ESTATE PROFESSIONAL AND CLIENT COMMUNICATIONS

(71) Applicant: Gregory Mizelle, Hudson, FL (US)

(72) Inventor: Gregory Mizelle, Hudson, FL (US)

(21) Appl. No.: 17/544,643

(22) Filed: Dec. 7, 2021

Related U.S. Application Data
(60) Provisional application No. 63/089,839, filed on Oct. 9, 2020.

(51) Int. Cl. G06Q 50/16; G06T 19/00; H04L 51/222; G06Q 20/06

(52) U.S. Cl. CPC G06Q 50/16; G06T 19/003; H04L 51/20; G06Q 20/065

(57) ABSTRACT

A location-based system for communicating with real estate professionals is disclosed. A client database stores a plurality of client information, a real estate professional database stores a plurality of real estate professional information, and a property database stores property information for a plurality of property listings. A communications module transmits a request for a service from a client to a real estate professional, and a scheduling module schedules the requested service. A GPS module then monitors the location of the real estate professional and provides a status of the location of the real estate professional, wherein the status is displayed on a status indicator to the client.

### CROSS-REFERENCE TO RELATED APPLICATIONS

The present application claims priority to U.S. Provisional Patent Application No. 63/089,839 filed Oct. 9, 2020, entitled “SYSTEM FOR LOCATION-BASED REAL ESTATE PROFESSIONAL AND CLIENT COMMUNICATIONS,” which is hereby incorporated by reference in its entirety.

### TECHNICAL FIELD

The embodiments generally relate to computerized location-based communications systems and, more particularly, to location-based systems for prospective home sellers and buyers to find and communicate with a real estate professional.

### BACKGROUND

A real estate agent is a person or business that arranges the selling, renting, or management of properties and other buildings. These agents are involved with marketing their services and the properties that they represent.

Often, real estate professionals use estate agency software to manage their buying applicants, property viewings, marketing, and property sales. Similarly, prospective buyers and sellers have various options for viewing properties, contacting real estate professionals, listing a property, etc. In either case, these systems do not offer a location-based system for connecting and communicating with the various parties associated with the processes of buying and selling a property.

### SUMMARY OF THE INVENTION

This summary is provided to introduce a variety of concepts in a simplified form that is further disclosed in the detailed description of the embodiments. This summary is not intended to identify key or essential inventive concepts of the claimed subject matter, nor is it intended for determining the scope of the claimed subject matter.

The embodiments provided herein relate to a location-based system for communicating with real estate professionals. A client database stores a plurality of client information, a real estate professional database stores a plurality of real estate professional information, and a property database stores property information for a plurality of property listings. A communications module transmits a request for a service from a client to a real estate professional, and a scheduling module schedules the requested service. A GPS module then monitors the location of the real estate professional and provides a status of the location of the real estate professional, wherein the status is displayed on a status indicator to the client.

The system allows for the client to request a viewing or other service provided by a real estate professional and receive real-time status updates of the location of the real-estate professional while travelling to and while executing a service. The system may be utilized to provide real estate professionals the opportunity to generate revenue by acting as a buyer's agent, especially when the real estate professional has no current listings.

The system may provide a platform wherein the client may engage with a virtual tour of a property. The system may receive the client's location in real time, and once within a pre-defined perimeter of the property, they may select to view the tour on their computing device (e.g., a smartphone). In some embodiments, once the client has interacted with the virtual tour of the property, they may be transmitted an amount of currency, such as a cryptocurrency.

In one aspect, the client may retain their cryptocurrency, resell the cryptocurrency to the real estate professional, or utilize the cryptocurrency to purchase an NFT. The NFT may include the escrow closing and chain of title of the property. The NFT may then be stored on the blockchain.

In one aspect, the property database is in operable communication with the MLS.

In one aspect, the property database is in operable communication with the IDX.

In one aspect, the request includes a service, a property, and a time period.

In one aspect, the user interface provides a map to display the location of a plurality of real estate professionals to the client.

In one aspect, the client browses the plurality of real estate professionals displayed on the map.

### BRIEF DESCRIPTION OF THE DRAWINGS

A complete understanding of the present embodiments and the advantages and features thereof will be more readily understood by reference to the following detailed description when considered in conjunction with the accompanying drawings wherein:

FIG. 1 illustrates a block diagram of a computing system, according to some embodiments;

FIG. 2 illustrates a block diagram of a computing system and an application program, according to some embodiments;

FIG. 3 illustrates a block diagram of the application program, according to some embodiments; and

FIG. 4 illustrates a flowchart of the process for transmitting a cryptocurrency associated with a client action, according to some embodiments.

### DETAILED DESCRIPTION

The specific details of the single embodiment or variety of embodiments described herein are to the described system and methods of use. Any specific details of the embodiments are used for demonstration purposes only, and no unnecessary limitations or inferences are to be understood thereon.

Before describing in detail exemplary embodiments, it is noted that the embodiments reside primarily in combinations of components and procedures related to the system. Accordingly, the system components have been represented, where appropriate, by conventional symbols in the drawings, showing only those specific details that are pertinent to understanding the embodiments of the present disclosure so as not to obscure the disclosure with details that will be readily apparent to those of ordinary skill in the art having the benefit of the description herein.

In this disclosure, the various embodiments may be a system, method, and/or computer program product at any possible technical detail level of integration. A computer program product can include, among other things, a computer-readable storage medium having computer-readable program instructions thereon for causing a processor to carry out aspects of the present disclosure.

In general, the embodiments provided herein relate to a location-based system, which allows for real estate professionals and clients to interact with one another. The system utilizes a global positioning system (GPS) to monitor the location of a real estate professional and/or a client in real-time. The system may be used by the client to connect with the real estate professional during various steps of the home buying and/or selling processes, such as when scheduling a tour of a property for sale. In one example, the client wishes to view a specific property and utilizes the location-based system to find a nearby real estate professional who is available to travel to the property location and provide access to the property. The client will be able to view the location of the real estate professional in real-time as they travel to the location of the property.

In some embodiments, the system provides a platform wherein the client may engage with a virtual tour of a property. The system may receive the client's location in real time, and once within a pre-defined perimeter of the property, they may select to view the tour on their computing device (e.g., a smartphone). In some embodiments, once the client has interacted with the virtual tour of the property, they may be transmitted an amount of currency, such as a cryptocurrency.

In some embodiments, the virtual tour may be a video recorded by the seller's agent, the buyer's agent, the previous property owner, property developer, or other individual associated with the sale of the property. The virtual tour may also be a 3-Dimensional simulation or rendering of the home. In some embodiments, the virtual tour may include a hyperlink to a webpage associated with the offer for sale of the property.

In some embodiments, compensation (i.e., payment of the currency or cryptocurrency) may be dynamic, such that the real estate professional can adjust the compensation amount based on various factors (e.g., popularity of the listing, previous offers, time spent engaging with the virtual tour, etc.).

In some embodiments, the real estate professional may purchase an amount of the cryptocurrency such that they are able to provide the cryptocurrency to clients who earn the cryptocurrency through engaging and/or otherwise interacting in a virtual tour of the property. In such, the real estate professional may incentivize the client to engage with the virtual tour of the property. The client may sell the cryptocurrency on the exchange, or the realtor may purchase the cryptocurrency back from the client upon closing of the property (as another form of incentive to continue through the purchasing process).

In some embodiments, the cryptocurrency may be used to purchase a non-fungible token (NFT) which represents ownership of the property. The NFT may include the escrow closing and chain of title stored on the blockchain.

As used herein, the term “real estate professional” relates to a real estate agent, real estate business, or representative thereof which conducts the various processes involved in buying and/or selling a property.

As used herein, the term “client” relates to any individual that is engaging in the various processes and events of buying and/or selling a property (such as touring properties, showing a property to potential buyers, etc.).

As used herein, the term “user” may relate to a real estate professional or a client unless further specified by the terms “real estate professional” or “client.”

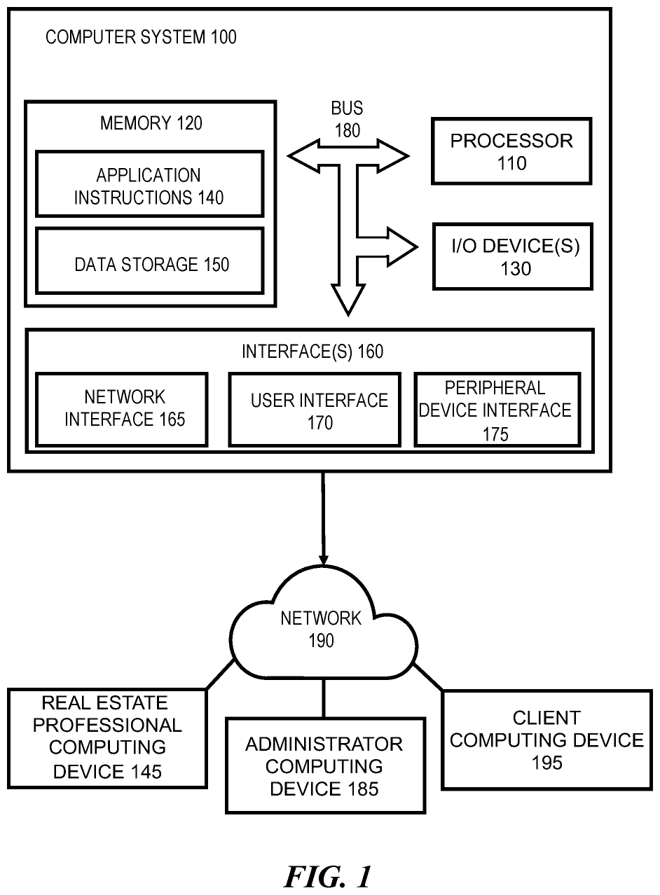

FIG. 1 illustrates an example of a computer system 100 that may be utilized to execute various procedures, including the processes described herein. The computer system 100 comprises a standalone computer or mobile computing device, a mainframe computer system, a workstation, a network computer, a desktop computer, a laptop, or the like. The computing device 100 can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive).

In some embodiments, the computer system 100 includes one or more processors 110 coupled to a memory 120 through a system bus 180 that couples various system components, such as an input/output (I/O) devices 130, to the processors 110. The bus 180 may be any of several types of bus structures including a memory bus or memory controller, a peripheral bus, and a local bus using any of a variety of bus architectures. For example, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, also known as Mezzanine bus.

In some embodiments, the computer system 100 includes one or more input/output (I/O) devices 130, such as video device(s) (e.g., a camera), audio device(s), and display(s) are in operable communication with the computer system 100. In some embodiments, similar I/O devices 130 may be separate from the computer system 100 and may interact with one or more nodes of the computer system 100 through a wired or wireless connection, such as over a network interface.

Processors 110 suitable for the execution of computer readable program instructions include both general and special purpose microprocessors and any one or more processors of any digital computing device. For example, each processor 110 may be a single processing unit or a number of processing units and may include single or multiple computing units or multiple processing cores. The processor(s) 110 can be implemented as one or more microprocessors, microcomputers, microcontrollers, digital signal processors, central processing units, state machines, logic circuitries, and/or any devices that manipulate signals based on operational instructions. For example, the processor(s) 110 may be one or more hardware processors and/or logic circuits of any suitable type specifically programmed or configured to execute the algorithms and processes described herein. The processor(s) 110 can be configured to fetch and execute computer readable program instructions stored in the computer-readable media, which can program the processor(s) 110 to perform the functions described herein.

In this disclosure, the term “processor” can refer to substantially any computing processing unit or device, including single-core processors, single-processors with software multithreading execution capability, multi-core processors, multi-core processors with software multithreading execution capability, multi-core processors with hardware multithread technology, parallel platforms, and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions described herein. Further, processors can exploit nano-scale architectures, such as molecular and quantum-dot based transistors, switches, and gates, to optimize space usage or enhance performance of user equipment. A processor can also be implemented as a combination of computing processing units.

In some embodiments, the memory 120 includes computer-readable application instructions 150, configured to implement certain embodiments described herein, and a database 150, comprising various data accessible by the application instructions 140. In some embodiments, the application instructions 140 include software elements corresponding to one or more of the various embodiments described herein. For example, application instructions 140 may be implemented in various embodiments using any desired programming language, scripting language, or combination of programming and/or scripting languages (e.g., C, C++, C #, JAVA, JAVASCRIPT, PERL, etc.).

In this disclosure, terms “store,” “storage,” “data store,” data storage,” “database,” and substantially any other information storage component relevant to operation and functionality of a component are utilized to refer to “memory components,” which are entities embodied in a “memory,” or components comprising a memory. Those skilled in the art would appreciate that the memory and/or memory components described herein can be volatile memory, nonvolatile memory, or both volatile and nonvolatile memory. Nonvolatile memory can include, for example, read only memory (ROM), programmable ROM (PROM), electrically programmable ROM (EPROM), electrically erasable ROM (EEPROM), flash memory, or nonvolatile random access memory (RAM) (e.g., ferroelectric RAM (FeRAM). Volatile memory can include, for example, RAM, which can act as external cache memory. The memory and/or memory components of the systems or computer-implemented methods can include the foregoing or other suitable types of memory.

Generally, a computing device will also include, or be operatively coupled to receive data from or transfer data to, or both, one or more mass data storage devices; however, a computing device need not have such devices. The computer readable storage medium (or media) can be a tangible device that can retain and store instructions for use by an instruction execution device. The computer readable storage medium can be, for example, an electronic storage device, a magnetic storage device, an optical storage device, an electromagnetic storage device, a semiconductor storage device, or any suitable combination of the foregoing. A non-exhaustive list of more specific examples of the computer readable storage medium can include: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. In this disclosure, a computer readable storage medium is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

In some embodiments, the steps and actions of the application instructions 140 described herein are embodied directly in hardware, in a software module executed by a processor, or in a combination of the two. A software module may reside in RAM, flash memory, ROM memory, EPROM memory, EEPROM memory, registers, a hard disk, a removable disk, a CD-ROM, or any other form of storage medium known in the art. An exemplary storage medium may be coupled to the processor 110 such that the processor 110 can read information from, and write information to, the storage medium. In the alternative, the storage medium may be integrated into the processor 110. Further, in some embodiments, the processor 110 and the storage medium may reside in an Application Specific Integrated Circuit (ASIC). In the alternative, the processor and the storage medium may reside as discrete components in a computing device. Additionally, in some embodiments, the events or actions of a method or algorithm may reside as one or any combination or set of codes and instructions on a machine-readable medium or computer-readable medium, which may be incorporated into a computer program product.

In some embodiments, the application instructions 140 for carrying out operations of the present disclosure can be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The application instructions 140 can execute entirely on the user's computer, partly on the user's computer, as a stand-alone software package, partly on the user's computer and partly on a remote computer, or entirely on the remote computer or server. In the latter scenario, the remote computer can be connected to the user's computer through any type of network, including a local area network (LAN) or a wide area network (WAN), or the connection can be made to an external computer (for example, through the Internet using an Internet Service Provider). In some embodiments, electronic circuitry including, for example, programmable logic circuitry, field-programmable gate arrays (FPGA), or programmable logic arrays (PLA) can execute the computer readable program instructions by utilizing state information of the computer readable program instructions to personalize the electronic circuitry, in order to perform aspects of the present disclosure.

In some embodiments, the system may operate using Web3 protocols such that the application operates on blockchains, decentralized networks of many peer-to-peer nodes (servers), or a combination thereof to form a crypto-economic protocol.

In some embodiments, the application instructions 140 can be downloaded to a computing/processing device from a computer readable storage medium, or to an external computer or external storage device via a network 190. A network adapter card or network interface in each computing/processing device receives computer readable program instructions from the network and forwards the computer readable application instructions 140 for storage in a computer readable storage medium within the respective computing/processing device.

In some embodiments, the computer system 100 includes one or more interfaces 160 that allow the computer system 100 to interact with other systems, devices, or computing environments. In some embodiments, the computer system 100 comprises a network interface 165 to communicate with a network 190. In some embodiments, the network interface 165 is configured to allow data to be exchanged between the computer system 100 and other devices attached to the network 190, such as other computer systems, or between nodes of the computer system 100. In various embodiments, the network interface 165 may support communication via wired or wireless general data networks, such as any suitable type of Ethernet network, for example, via telecommunications/telephony networks such as analog voice networks or digital fiber communications networks, via storage area networks such as Fiber Channel SANs, or via any other suitable type of network and/or protocol. Other interfaces include the user interface 170 and the peripheral device interface 175.

In some embodiments, the network 190 corresponds to a local area network (LAN), wide area network (WAN), the Internet, a direct peer-to-peer network (e.g., device to device Wi-Fi, Bluetooth, etc.), and/or an indirect peer-to-peer network (e.g., devices communicating through a server, router, or other network device). The network 190 can comprise copper transmission cables, optical transmission fibers, wireless transmission, routers, firewalls, switches, gateway computers and/or edge servers. The network 190 can represent a single network or multiple networks. In some embodiments, the network 190 used by the various devices of the computer system 100 is selected based on the proximity of the devices to one another or some other factor. For example, when a first user device and second user device are near each other (e.g., within a threshold distance, within direct communication range, etc.), the first user device may exchange data using a direct peer-to-peer network. But when the first user device and the second user device are not near each other, the first user device and the second user device may exchange data using a peer-to-peer network (e.g., the Internet). The Internet refers to the specific collection of networks and routers communicating using an Internet Protocol (“IP”) including higher level protocols, such as Transmission Control Protocol/Internet Protocol (“TCP/IP”) or the Uniform Datagram Packet/Internet Protocol (“UDP/IP”).

Any connection between the components of the system may be associated with a computer-readable medium. For example, if software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. As used herein, the terms “disk” and “disc” include compact disc (CD), laser disc, optical disc, digital versatile disc (DVD), floppy disk, and Blu-ray disc; in which “disks” usually reproduce data magnetically, and “discs” usually reproduce data optically with lasers. Combinations of the above should also be included within the scope of computer-readable media. In some embodiments, the computer-readable media includes volatile and nonvolatile memory and/or removable and non-removable media implemented in any type of technology for storage of information, such as computer-readable instructions, data structures, program modules, or other data. Such computer-readable media may include RAM, ROM, EEPROM, flash memory or other memory technology, optical storage, solid state storage, magnetic tape, magnetic disk storage, RAID storage systems, storage arrays, network attached storage, storage area networks, cloud storage, or any other medium that can be used to store the desired information and that can be accessed by a computing device. Depending on the configuration of the computing device, the computer-readable media may be a type of computer-readable storage media and/or a tangible non-transitory media to the extent that when mentioned, non-transitory computer-readable media exclude media such as energy, carrier signals, electromagnetic waves, and signals per se.

In some embodiments, the system is world-wide-web (www) based, and the network server is a web server delivering HTML, XML, etc., web pages to the computing devices. In other embodiments, a client-server architecture may be implemented, in which a network server executes enterprise and custom software, exchanging data with custom client applications running on the computing device.

In some embodiments, the system can also be implemented in cloud computing environments. In this context, “cloud computing” refers to a model for enabling ubiquitous, convenient, on-demand network access to a shared pool of configurable computing resources (e.g., networks, servers, storage, applications, and services) that can be rapidly provisioned via virtualization and released with minimal management effort or service provider interaction, and then scaled accordingly. A cloud model can be composed of various characteristics (e.g., on-demand self-service, broad network access, resource pooling, rapid elasticity, measured service, etc.), service models (e.g., Software as a Service (“SaaS”), Platform as a Service (“PaaS”), Infrastructure as a Service (“IaaS”), and deployment models (e.g., private cloud, community cloud, public cloud, hybrid cloud, etc.).

As used herein, the term “add-on” (or “plug-in”) refers to computing instructions configured to extend the functionality of a computer program, where the add-on is developed specifically for the computer program. The term “add-on data” refers to data included with, generated by, or organized by an add-on. Computer programs can include computing instructions, or an application programming interface (API) configured for communication between the computer program and an add-on. For example, a computer program can be configured to look in a specific directory for add-ons developed for the specific computer program. To add an add-on to a computer program, for example, a user can download the add-on from a website and install the add-on in an appropriate directory on the user's computer.

In some embodiments, the computer system 100 may include a real estate professional computing device 145, an administrator computing device 185 and a client computing device 195 each in communication via the network 190. The real estate professional computing device 145 may be utilized by a real estate professional to communicate with clients, send and receive a currency (e.g., a cryptocurrency), or otherwise interact with the various functionalities of the system. The administrator computing device 185 is utilized by an administrative user to moderate content and to perform other administrative functions. The client computing device 195 may be connected to or in communication with the network to allow the client to communicate with various real estate professionals, engage in virtual tours of a property, send and receive currency, purchase an NFT corresponding to a real estate transaction, and otherwise engage in the various functionalities of the system.

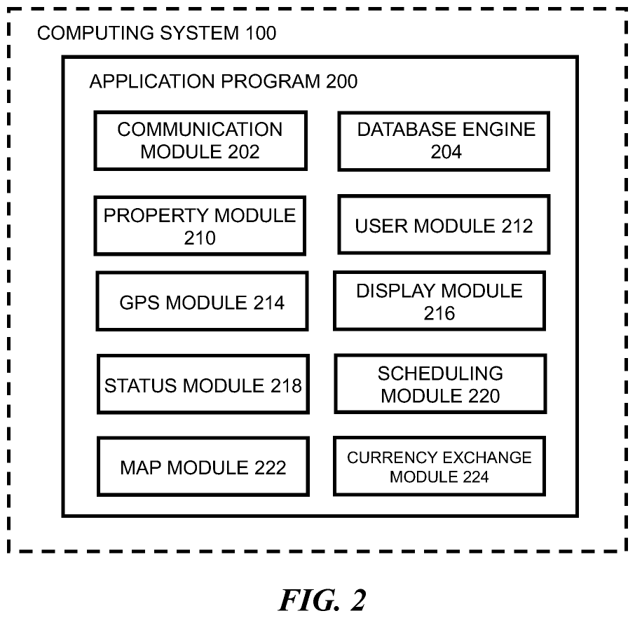

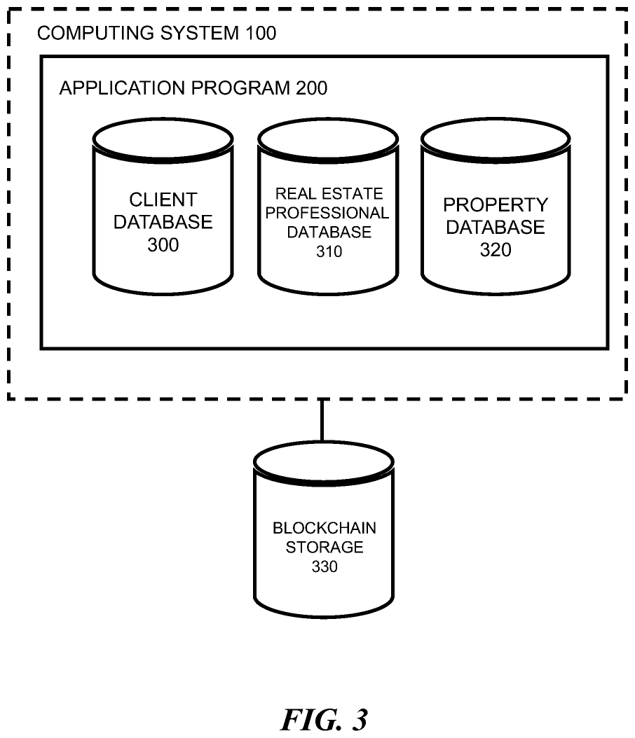

FIGS. 2 and 3 illustrate an example computer architecture for the application program 200 operated via the computing system 100. The computer system 100 comprises several modules and engines configured to execute the functionalities of the application program 200, and a database engine 204 configured to facilitate how data is stored and managed in one or more databases. In particular, FIG. 2 is a block diagram showing the modules and engines needed to perform specific tasks within the application program 200, and FIG. 3 is a block diagram showing the various databases utilized by the various modules.

Referring to FIG. 2, the computing system 100 operating the application program 200 comprises one or more modules having the necessary routines and data structures for performing specific tasks, and one or more engines configured to determine how the platform manages and manipulates data. In some embodiments, the application program 200 comprises one or more of a communication module 202, a database engine 204, a property module 210, a user module 212, a GPS module 214, a display module 216, a status module 218, a scheduling module 220, a map module 222, and a currency exchange module 224.

In some embodiments, the communication module 202 is configured for receiving, processing, and transmitting a user command and/or one or more data streams. In such embodiments, the communication module 202 performs communication functions between various devices, including the real estate professional computing device 145, the administrator computing device 185, and a client computing device 195. In some embodiments, the communication module 202 is configured to allow one or more users of the system, including a third-party, to communicate with one another. In some embodiments, the communications module 202 is configured to maintain one or more communication sessions with one or more servers, the administrative computing device 185, and/or one or more client computing device(s) 195. In some embodiments, the communication module 202 permits communications between the real estate professional (or representative thereof) and clients who are seeking a service from the real estate professional.

In some embodiments, a database engine 204 is configured to facilitate the storage, management, and retrieval of data to and from one or more storage mediums, such as the one or more internal databases described herein. In some embodiments, the database engine 204 is coupled to an external storage system. In some embodiments, the database engine 204 is configured to apply changes to one or more databases. In some embodiments, the database engine 204 comprises a search engine component for searching through thousands of data sources stored in different locations.

In some embodiments, the property module 210 allows a property to be added to the system and stored in the property database. The property may be associated with various property information including the location, owner, pricing information, property details, property type, and virtual tour data.

In some embodiments, the user module 212 facilitates the creation of a user account for the application system. The user module 212 may allow the user to create a user profile which includes user information, user preferences, establish user credentials, and the like.

In some embodiments, the GPS module 214 is in operable communication with the computing system to receive location information (latitude and longitude coordinates) of the real estate professional's computing device 145 and transmits the location to a map module 222, which will display the real-time location of the real estate professional to the client. The GPS module 214 may actively or passively monitor the locations of multiple real estate professionals to determine a preferred or available real estate professional for performing a service requested by a client (e.g., viewing a property)

In some embodiments, the display module 216 is configured to display one or more graphic user interfaces, including, e.g., one or more user interfaces, one or more consumer interfaces, one or more video presenter interfaces, etc. In some embodiments, the display module 216 is configured to temporarily generate and display various pieces of information in response to one or more commands or operations. The various pieces of information or data generated and displayed may be transiently generated and displayed, and the displayed content in the display module 216 may be refreshed and replaced with different content upon the receipt of different commands or operations.

In some embodiments, the status module 218 displays a status indicator once the client has connected with the real estate professional and established a service or services that the real estate professional will provide. The status module 218 may display an indicator having variations to indicate various stages for a process. For example, the indicator may indicate the stages of accepting a request from a client, being en-route to the property location, and arriving at the property location. The indicator will be displayed to the client and provide updates based on the location of the real estate professional in reference to the requested service.

In some embodiments, the scheduling module 220 allows the real-estate professional and/or the client to submit a request to schedule a service at a predetermined location and time period (e.g., viewing property A at 10:00 AM on Tuesday). Each user may then be provided with reminders for the scheduled service at user-determined time intervals established in the user's settings.

In some embodiments, the map module 222 provides a map of each real estate professional within a search radius. The client may then browse the real estate professionals, their profile information, credentials, availability, specialties, etc. to select a preferred real estate professional for a particular service during a specific time period.

In some embodiments, the currency exchange module 224 permits the exchange of a currency, such as a cryptocurrency. The client and/or the real estate professional may each send and/or receive the currency via the platform. The currency exchange module 224 may be communication with a blockchain storage 330 which allows for the ledger to be established on the blockchain.

FIG. 3 illustrates the computing system 100 in operable communication with the application program 200 having a plurality of databases in communication thereto. A client database 300 is operable to store client data including user preferences, user history, etc. The client database 212 may information related to each client utilizing the system, including client contact information, client profile information, client preferences, and historical client data. The real estate professional database 310 stores real estate professional information including their preferences, associated properties, currency information, etc. The property database 320 stores property information including the virtual tour of the property. A blockchain storage 330 is in operable communication with the computing system to allow for a blockchain ledger to be accessed and to permit the exchange of a cryptocurrency, NFT, or similar form of currency stored on the blockchain.

In some embodiments, the computing system may be in operable communication with the Multiple Listing Service (MLS) such that the information contained therein may be displayed or otherwise interacted with by the system. In another embodiment, the system may be linked to the MLS to allow the user to interact with the various functionalities of the MLS. In such, the system may be in communication with the Internet Data Exchange (IDX) to allow the real estate professional to show property listings and associated information thereof via the system.

The location monitoring system which allows the system to monitor the location of the real estate professionals when interacting with a client and while travelling to a property location once requested by the client. A GPS module 214 receives location information (latitude and longitude coordinates) of the real estate professional's computing device 145 and transmits the location to a map module 222, which will display the real-time location of the real estate professional to the client. The GPS module 214 may actively or passively monitor the locations of multiple real estate professionals to determine a preferred or available real estate professional for performing a service requested by a client (e.g., viewing a property). A status module 218 displays a status indicator once the client has connected with the real estate professional and established a service or services that the real estate professional will provide. In some embodiments, the status module 218 may display an indicator having variations to indicate various stages for a process such as by indicating if the real estate professional is travelling to the property. The indicator will be displayed to the client, via the display module 216 and provide updates based on the location of the real estate professional in reference to the requested service.

In some embodiments, the location monitoring system provides a map, via the map module 222 of each real estate professional within a search radius. The client may then browse the real estate professionals, their profile information, credentials, availability, specialties, etc. to select a preferred real estate professional for a particular service during a specific time period.

One skilled in the arts will readily understand that the system, while described for real estate professionals, may also be implemented to contact, schedule, and monitor the location of various professions (whether licensed or unlicensed) such as, but not limited to: plumbers, roofers, landscapers, housekeepers, electricians, etc.

In some embodiments, the GPS module 214 is operable to track the location of the real estate professional and/or other users of the system during tours of the property, such as during private tours as well as open houses. In such, the user may utilize the system to monitor the location of the real estate professional while the real estate professional is within the property and performing a tour, open house, or other service within or around the property.

In some embodiments, the user may select one or more indicators to correspond to the type of user they are (e.g., a real estate professional, buyer, seller, etc.), or the service they are performing at a particular property (e.g., for a real tour, open house, etc.). For example, the indicator may illustrate a “B” for buyer, “S” for seller, “OH” for open house, or “RT” for real tour. The indicator is displayed on the map interface which can be easily interpreted by the user to determine where a user is located and/or where a service is being performed.

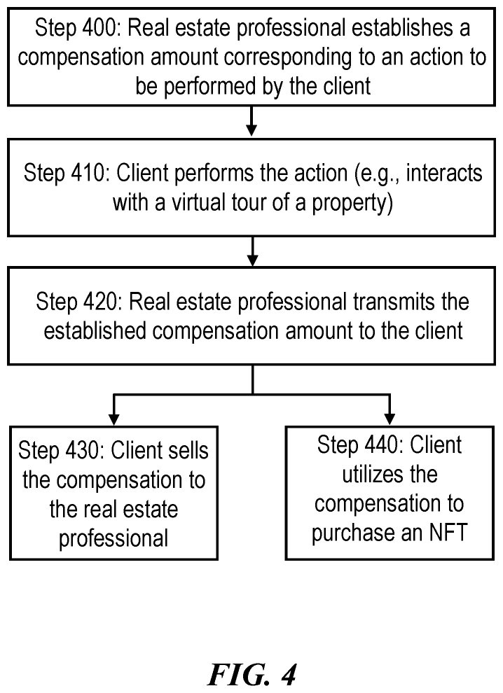

FIG. 4

In this disclosure, the various embodiments are described with reference to the flowchart illustrations and/or block diagrams of methods, apparatus (systems), and computer program products. Those skilled in the art would understand that each block of the flowchart illustrations and/or block diagrams, and combinations of blocks in the flowchart illustrations and/or block diagrams, can be implemented by computer readable program instructions. The computer readable program instructions can be provided to a processor of a general purpose computer, special purpose computer, or other programmable data processing apparatus to produce a machine, such that the instructions, which execute via the processor of the computer or other programmable data processing apparatus, create means for implementing the functions or acts specified in the flowchart and/or block diagram block or blocks. The computer readable program instructions can be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks. The computer readable program instructions can be loaded onto a computer, other programmable data processing apparatus, or other device to cause a series of operational acts to be performed on the computer, other programmable apparatus, or other device to produce a computer implemented process, such that the instructions that execute on the computer, other programmable apparatus, or other device implement the functions or acts specified in the flowchart and/or block diagram block or blocks.

In this disclosure, the block diagrams in the Figures illustrate the architecture, functionality, and operation of possible implementations of systems, methods, and computer program products according to the various embodiments. Each block in the flowchart or block diagrams can represent a module, segment, or portion of instructions, which comprises one or more executable instructions for implementing the specified logical function(s). In some embodiments, the functions noted in the blocks can occur out of the order noted in the Figures. For example, two blocks shown in succession can, in fact, be executed concurrently or substantially concurrently, or the blocks can sometimes be executed in the reverse order, depending upon the functionality involved. In some embodiments, each block of the block diagrams and/or flowchart illustration, and combinations of blocks in the block diagrams and/or flowchart illustration, can be implemented by a special purpose hardware-based system that performs the specified functions or acts or carry out combinations of special purpose hardware and computer instructions.

In this disclosure, the subject matter has been described in the general context of computer-executable instructions of a computer program product running on a computer or computers, and those skilled in the art would recognize that this disclosure can be implemented in combination with other program modules. Generally, program modules include routines, programs, components, data structures, etc. that perform particular tasks and/or implement particular abstract data types. Those skilled in the art would appreciate that the computer-implemented methods disclosed herein can be practiced with other computer system configurations, including single-processor or multiprocessor computer systems, mini-computing devices, mainframe computers, as well as computers, hand-held computing devices (e.g., PDA, phone), microprocessor-based or programmable consumer or industrial electronics, and the like. The illustrated embodiments can be practiced in distributed computing environments where tasks are performed by remote processing devices that are linked through a communications network. Some embodiments of this disclosure can be practiced on a stand-alone computer. In a distributed computing environment, program modules can be located in both local and remote memory storage devices.

In this disclosure, the terms “component,” “system,” “platform,” “interface,” and the like, can refer to and/or include a computer-related entity or an entity related to an operational machine with one or more specific functionalities. The disclosed entities can be hardware, a combination of hardware and software, software, or software in execution. For example, a component can be a process running on a processor, a processor, an object, an executable, a thread of execution, a program, and/or a computer. By way of illustration, both an application running on a server and the server can be a component. One or more components can reside within a process and/or thread of execution and a component can be localized on one computer and/or distributed between two or more computers. In another example, respective components can execute from various computer readable media having various data structures stored thereon. The components can communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor. In such a case, the processor can be internal or external to the apparatus and can execute at least a part of the software or firmware application. As another example, a component can be an apparatus that provides specific functionality through electronic components without mechanical parts, wherein the electronic components can include a processor or other means to execute software or firmware that confers at least in part the functionality of the electronic components. In some embodiments, a component can emulate an electronic component via a virtual machine, e.g., within a cloud computing system.

The phrase “application” as is used herein means software other than the operating system, such as Word processors, database managers, Internet browsers and the like. Each application generally has its own user interface, which allows a user to interact with a particular program. The user interface for most operating systems and applications is a graphical user interface (GUI), which uses graphical screen elements, such as windows (which are used to separate the screen into distinct work areas), icons (which are small images that represent computer resources, such as files), pull-down menus (which give a user a list of options), scroll bars (which allow a user to move up and down a window) and buttons (which can be “pushed” with a click of a mouse). A wide variety of applications is known to those in the art.

The phrases “Application Program Interface” and API as are used herein mean a set of commands, functions and/or protocols that computer programmers can use when building software for a specific operating system. The API allows programmers to use predefined functions to interact with an operating system, instead of writing them from scratch. Common computer operating systems, including Windows, Unix, and the Mac OS, usually provide an API for programmers. An API is also used by hardware devices that run software programs. The API generally makes a programmer's job easier, and it also benefits the end user since it generally ensures that all programs using the same API will have a similar user interface.

The phrase “central processing unit” as is used herein means a computer hardware component that executes individual commands of a computer software program. It reads program instructions from a main or secondary memory, and then executes the instructions one at a time until the program ends. During execution, the program may display information to an output device such as a monitor.

The term “execute” as is used herein in connection with a computer, console, server system or the like means to run, use, operate or carry out an instruction, code, software, program and/or the like.

In this disclosure, the descriptions of the various embodiments have been presented for purposes of illustration and are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein. Thus, the appended claims should be construed broadly, to include other variants and embodiments, which may be made by those skilled in the art.

What is claimed is:

1. A location-based system for communicating with real estate professionals, the system comprising:
a client database to store a plurality of client information;
a real estate professional database to store a plurality of real estate professional information;
a property database to store property information for a plurality of property listings;
a communications module to transmit a request for a service from a client to a real estate professional;
a scheduling module to schedule the requested service; and
a GPS module to monitor the location of the real estate professional and provide a status of the location of the real estate professional, wherein the status is displayed on a status indicator, via a computing device, to the client.

2. The system of claim 1, wherein the property database is in operable communication with the MLS.

3. The system of claim 2, wherein the property database is in operable communication with the DX.

4. The system of claim 1, wherein the request includes a service, a property, and a time period.

5. The system of claim 1, further comprising a map to display the location of a plurality of real estate professionals to the client.

6. The system of claim 5, wherein the client is able to browse the plurality of real estate professionals displayed on the map and select a preferred real estate professional from whom to request the service.

7. A system for the location-based communicating with real estate professionals, comprising:
at least one user computing device in operable connection with a user network;
an application server in operable communication with the user network, the application server configured to host an application system for providing a platform for a communicating with a real estate professional, the application system having a user interface for providing access to the application system through the user computing device;
a GPS module for determining if the user is within a predefined proximity to a property;
a display module for providing a virtual tour of the property;
a currency exchange module for providing a compensation upon completion of viewing the virtual tour of the property.

8. The system of claim 7, wherein the compensation is a predetermined amount of a cryptocurrency.

9. The system of claim 8, further comprising a map module to provide a map via the display module.

10. The system of claim 9, further comprising a blockchain storage in communication with the computing system.

11. The system of claim 10, wherein the property database is in operable communication with the MLS.

12. The system of claim 11, wherein the property database is in operable communication with the IDX.

13. The system of claim 12, wherein the request includes a service, a property, and a time period.

14. The system of claim 13, further comprising a map to display the location of a plurality of real estate professionals to the client.

15. The system of claim 14, wherein the client browses the plurality of real estate professionals displayed on the map and select a preferred real estate professional from whom to request the service.

16. A method for providing location-based communications with real estate professionals, the system comprising:
monitoring, via a GPS module, the locations of a plurality of real estate professionals;
selecting, via a client, at least one of the plurality of real estate professionals;
transmitting, via a client operating a computing device, a request to the real estate professional for at least one service; and
monitoring, via the GPS module, the location of the real estate professional while travelling to a property indicated by the request and executing the service indicated by the request.

17. The method of claim 16, further comprising the steps of:
viewing a virtual tour of a property; and
transmitting a compensation upon viewing of the virtual property.

18. The method of claim 17, wherein a currency exchange module facilitates the transmission of the compensation.

19. The method of claim 18, wherein the compensation is a cryptocurrency.

20. The method of claim 19, further comprising a blockchain storage.
